(19) United States
(12) Patent Application Publication
(10) Pub. No.: US 2026/0196912 A1
(43) Pub. Date: Jul. 9, 2026

(54) NON-CONTACT COUPLING COMPONENT FOR A VEHICLE

(71) Applicant: Woodward, Inc., Fort Collins, CO (US)

(72) Inventors: Jeffrey T. Voiles, Niles, IL (US); Thomas H. Block, Evanston, IL (US); Torrey R. Filanc-Bowen, La Grange Park, IL (US); Michel D. Swanson, Elgin, IL (US)

(21) Appl. No.: 19/010,859

(22) Filed: Jan. 6, 2025

(51) Int. Cl. H02K 49/10

(52) U.S. Cl. CPC H02K 49/102

(57) ABSTRACT

An exemplary control system for a vehicle includes: an operator interface; a sensing system configured to detect a variable position of the operator interface and cause a change in operation of the vehicle; a drive component; and a non-contact coupling component coupled to the operator interface and to the drive component, wherein the non-contacting coupling component exhibits a torque transfer function, wherein the non-contact coupling component is configured to receive a torque from the drive component and, according to the torque transfer function, the non-contact coupling component is configured to provide a torque to the operator interface to cause movement of the operator interface, and wherein the variable position of the operator interface is configured to vary independently from a position of the non-contact coupling component.

### CROSS REFERENCE TO RELATED APPLICATIONS

[Not Applicable]

### BACKGROUND

Generally, this application relates to non-contact coupling devices for a motor or an operator interface (e.g., a lever) through which a user interacts with a vehicle, such as an aircraft. While an aircraft is primarily discussed herein, the embodiments disclosed herein may be suitable for other types of vehicles or other systems.

In aircraft actuation mechanisms, an input member can be commanded at a prescribed speed or torque, while an output member can respond by moving through a displacement either equivalent to that of the input, as in a direct drive, or proportional to the input. There can be several power sources that these mechanisms can potentially draw from, such as gas pressure or electric signaling type power sources. An actuator can either produce rotational or linear motion at the output, and the output can act along the same axis of motion as the input or change in direction.

A subset of actuation mechanisms can be contact actuation mechanisms, in which motion is transmitted entirely through rigid connections. In such mechanisms, the output may not rotate or translate independently of the input unless the connection is physically disengaged or broken. Examples of contact actuation mechanisms include gears, linkages, and lead screws. Certain factors may affect the lifespan of these components, such as heat transfer, surface wear, and/or cyclic loading.

Levers can be used in actuators to allow a user to manually command the system or provide mechanical input to generate an electrical output, where the output can be proportional to the rotational displacement of the lever about an axis. This signal may then be used to trigger a mechanical response from the system. For example, levers can be used in cockpit control applications to allow pilots to command an airplane during flight, a characteristic of modern fly-by-wire systems. Motors can be used in these lever assemblies to facilitate automated tactile feedback to the lever. To regain manual control of the lever, the user may either overcome the motor resistance felt at the lever or decouple the lever from the motor.

### SUMMARY

According to embodiments, a control system for a vehicle includes: an operator interface; a sensing system configured to detect a variable position of the operator interface and cause a change in operation of the vehicle; a drive component; and a non-contact coupling component coupled to the operator interface and to the drive component, wherein the non-contacting coupling component exhibits a torque transfer function, wherein the non-contact coupling component is configured to receive a torque from the drive component and, according to the torque transfer function, the non-contact coupling component is configured to provide a torque to the operator interface to cause movement of the operator interface, and wherein the variable position of the operator interface is configured to vary independently from a position of the non-contact coupling component.

According to an embodiment, the control system is configured such that a movement of the operator interface causes a responsive movement in the drive component.

According to an embodiment, drive component is configured to provide a torque to the non-contact coupling component in response to the movement of the operator interface causing the responsive movement in the drive component, such that a feedback torque is received by the operator interface.

According to an embodiment, the control system is configured such that a movement of the operator interface does not cause a responsive movement in the drive component.

According to an embodiment, the non-contact coupling component includes a plurality of magnets configured to effect coupling between the operator interface and the drive component.

According to an embodiment, the non-contact coupling component includes a damping fluid configured to effect coupling between the operator interface and the drive component.

According to an embodiment, the damping fluid comprises a magnetorheological fluid.

According to an embodiment, the non-contact coupling component comprises a planetary magnetic gear system.

According to an embodiment, the drive component comprises a motor.

According to an embodiment, the variable position of the operator interface is configured to vary independently from a position of the non-contact coupling component in response to receiving an external force at the operator interface.

According to an embodiment, the non-contact coupling component has a slip torque that is adjustable by selectively aligning and misaligning pole pairs in a first portion of an adjustable rotating member and a second portion of the adjustable rotating member.

According to an embodiment, the non-contact coupling component comprises: a first rotating member with a pattern of magnetic poles alternating between north and south polarity; a second rotating member concentric with the first rotating member, wherein the second rotating member includes magnetic poles in a different pattern than the magnetic poles of the first rotating member, wherein the second rotating member comprises the adjustable rotating member; and a third rotating member, wherein the third rotating member modulates the magnetic flux between the first rotating member and the second rotating member.

According to embodiments, a method for controlling an operator interface of a vehicle includes: detecting a variable position of the operator interface using a sensing system; in response to detecting a change in a position of the operator interface, cause a change in operation of the vehicle; receive, at a non-contact coupling component, a torque from a drive component; according to a torque transfer function of the non-contact coupling component, provide, by the non-contact coupling component, a torque to the operator interface to cause movement of the operator interface; and varying the position of the operator interface independently from a position of the non-contact coupling component.

According to an embodiment, the method further includes: moving the operator interface; and in response to moving the operator interface, causing a responsive movement in the drive component.

According to an embodiment, the method further includes providing, by the drive component, a torque to the non-contact coupling component in response to moving the operator interface causing the responsive movement in the drive component, such that a feedback torque is received by the operator interface.

According to an embodiment, a movement of the operator interface does not cause a responsive movement in the drive component.

According to an embodiment, the non-contact coupling component includes a plurality of magnets configured to effect coupling between the operator interface and the drive component.

According to an embodiment, the non-contact coupling component includes a damping fluid configured to effect coupling between the operator interface and the drive component.

According to an embodiment, the damping fluid comprises a magnetorheological fluid.

According to an embodiment, the non-contact coupling component comprises a planetary magnetic gear system.

According to an embodiment, the drive component comprises a motor.

According to an embodiment, the method further includes varying the position of the operator interface independently from a position of the non-contact coupling component in response to receiving an external force at the operator interface.

According to an embodiment, the non-contact coupling component has a slip torque that is adjustable by selectively aligning and misaligning pole pairs in a first portion of an adjustable rotating member and a second portion of the adjustable rotating member.

According to an embodiment, the non-contact coupling component comprises: a first rotating member with a pattern of magnetic poles alternating between north and south polarity; a second rotating member concentric with the first rotating member, wherein the second rotating member includes magnetic poles in a different pattern than the magnetic poles of the first rotating member, wherein the second rotating member comprises the adjustable rotating member; and a third rotating member, wherein the third rotating member modulates the magnetic flux between the first rotating member and the second rotating member.

### BRIEF DESCRIPTION OF SEVERAL VIEWS OF THE DRAWINGS

FIGS. 1A and 1B illustrate a lateral cross-sectional view and a front elevation view of a portion of a control system including operator interface, a first type of non-contact coupling component, and a motor according to embodiments.

FIGS. 1C, 1D, and 1E illustrates a lateral cross-sectional view and alignment and misalignment of pole pairs in a portion of a control system, according to embodiments.

FIG. 2A illustrates an operator interface and a second type of non-contact coupling component, according to embodiments.

FIG. 2B illustrates an operator interface and the second type of non-contact coupling component with a motor and a worm gear, according to embodiments.

FIG. 3 illustrates a block diagram of a control system for a vehicle with a reversible drive component, according to embodiments.

FIG. 4 illustrates a block diagram of a control system for a vehicle with an irreversible drive component, according to embodiments.

FIG. 5 illustrates a block diagram of a control system for a vehicle with a magnetic clutch, according to embodiments.

FIG. 6 is a flowchart for a method of controlling a vehicle, according to embodiments.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

Contact actuation devices may face limitations regarding performance and lifespan, which require attention during the design process to mitigate. The potential for mechanical wear, for example, requires consideration. Rigid interfaces, such as the teeth on gears or the threads on lead screws, can witness localized stress and may be subject to strain or deformation, and may be sources of mechanical jams. Sliding surfaces can be at higher risk of surface wear due to friction, and may require additional surface treatment processes to be used to improve hardness and durability of parts. Contact actuation devices may be adversely impacted by mechanical and thermal effects. For example, friction between moving parts may generate energy in the form of heat, which can cause the operating temperature of nearby components to rise to undesirable levels. All of these can lead to failure of a contact actuation device.

There is additionally room for cost improvement. Contact coupling and decoupling methods for a motor-lever device can be intricate and costly, since redundant switch circuits are often implemented to disconnect the motor and allow manual control of the lever, as may be mandated by hazard requirements. Additionally, gear trains and friction clutches with large part counts may be used to transmit torque from the motor and attain desired force feel characteristics at the lever, respectively. Thus, there is a need for reducing the contact points that can lead to failure of actuation devices as well as cost improvements. The present non-contact coupling component described herein eliminates the contacts points as well reducing manufacturing cost over conventional contact actuation devices.

Certain embodiments of a non-contact coupling component described herein can satisfy the traditional safety requirements of a motor-lever device with fewer parts, as it can function as a gear train with an inherent slip clutch feature. A magnetic gear set may be used to illustrate this dynamic: an input shaft transmits torque to an output shaft until the torque reaches a certain threshold, and the two shafts will slip relative to each other if the torque exceeds this limit. As an added benefit, this design can mitigate the performance risks that befall rigid actuation mechanisms, since magnetic gears do not possess gear teeth or other small features that act as stress concentrations on traditional actuation components.

Another benefit of this configuration is that it allows flexibility with respect to customizing force feel characteristics. A magnetic gear set, for example, can use a custom magnet pole pattern that can simulate mechanical detents and other complex force feel gradients. Also, a magnetorheological fluid can optionally be used to fill the gap(s) between moving parts, such that the damping effect at the lever can be electrically tuned.

A damping device could also be used as a coupling method in scenarios that are dependent on speed. Alternatively, damping fluid can optionally be distributed throughout the gaps between any or all the moving members in a non-contact coupling component. This fluid may optionally have magnetorheological properties, such that when coils and permeable materials are incorporated in the design, the magnetorheological fluid's viscosity will vary (e.g., proportionally) to the current travelling through the coils, thus giving the ability to emulate a torque transfer function. Also, in the absence of this fluid, the same principle of coils and permeable materials being incorporated into the design may be used to emulate or adjust a torque transfer function by varying the magnitude of magnetic coupling. While certain techniques are described as emulating a torque transfer function, as used herein, they are understood to be part of the torque transfer function unless specified otherwise. For example, the effect of the damping fluid can be a factor in addition to the conventional torque transfer function of a component, and will be understood to be part of an overall torque transfer function (or more simply, torque transfer function), unless specified otherwise.

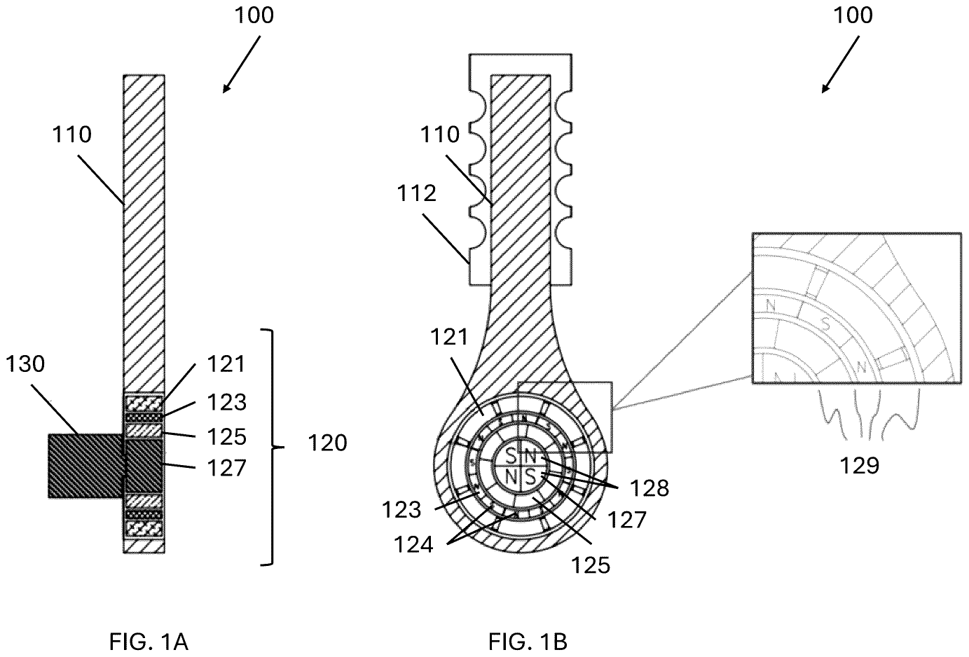

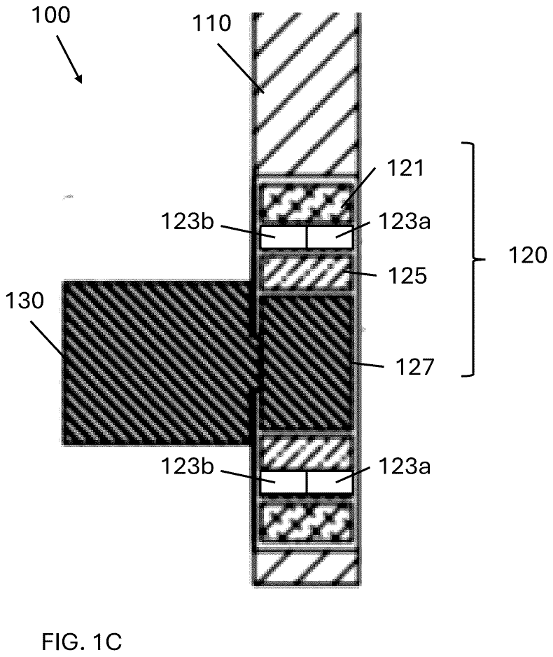

FIGS. 1A and 1B illustrate a lateral cross-sectional view and a front elevation view of a portion of a control system 100 for a vehicle, respectively, the control system 100 including operator interface 110, a first type of non-contact coupling component 120, and a motor 130 according to embodiments. The vehicle may be an aircraft, an automobile, a watercraft, or machinery, such as a crane, or the like. Also included in the control system 100, but not shown, is a sensing system. Generally, an operator of the vehicle engages with the operator interface 110. Depending on the type of operator interface 110, the operator can engage the operator interface 110 with a hand or foot. In the example shown, the operator engages the operator interface 110 through a handle 112. Examples of the operator interface 110 include a lever, a joystick, a foot pedal, a dial, a knob plunger, or the like. In the example of FIGS. 1A and 1B, the operator interface 110 includes a lever.

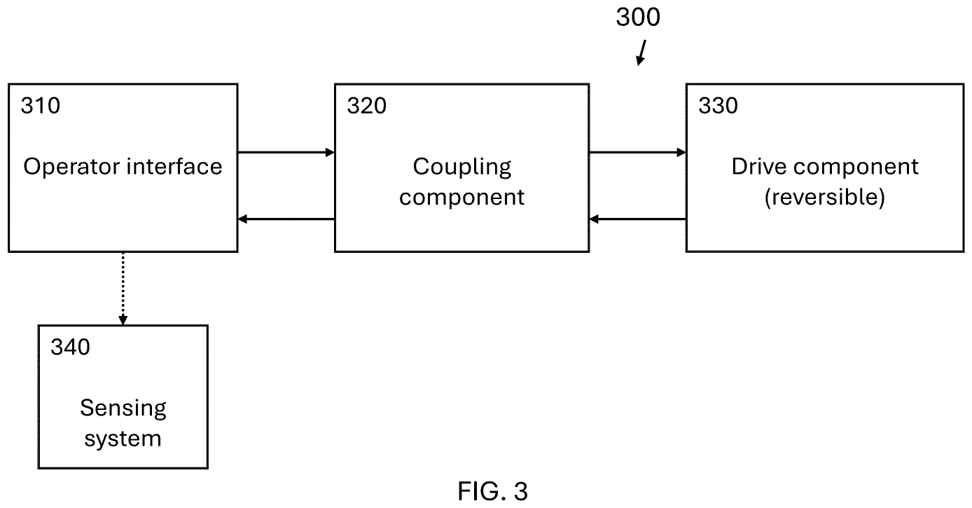

The sensing system detects the position of the operator interface 110, and responsively causes a change in one or more operations of a vehicle. An example of a sensing system is shown in FIG. 3 (sensing system 340), which will be discussed in greater detail. The sensing system can communicate with or provide signals to a processor (not shown), which may provide controls to change one or more operations of the vehicle (e.g., the directional control, the propulsion system energy, or the aerodynamic drag characteristics). Sensors in the sensing system can be contact sensors, optical sensors, electro-magnetic sensors, capacitive sensors, variable displacement transformers, potentiometers, hall-effect sensors and/or the like.

The non-contact coupling component 120 couples the operator interface 110 with the motor 130. The operator interface 110 has an aperture, opening, or recess that receives at least a portion of the non-contact coupling component 120. An example of such is shown in FIG. 1A. Further, although a motor 130 is described herein, other drive components can be used, such as mechanical or hydraulic drive components. The motor 130 can be a DC stepper motor, brush motor, brushless motor, induction motor, and/or the like.

The non-contact coupling component 120 is “non-contact” in that there is at least one gap filled with fluid between solid components along the path of coupling between the operator interface 110 and the motor 130. The fluid can be gas (e.g., air) or liquid (e.g., a type of damping fluid, such as a magnetorheological fluid). In the example of a gas, magnetic or electromagnetic coupling across the fluid-filled gap can effect coupling. In the example of a liquid, the liquid itself can effect coupling. Further, in the example of a liquid, coupling can be effected via magnetic or electromagnetic coupling across the fluid-filled gap.

The non-contact coupling component 120 receives a torque from the operator interface 110 when movement is initiated at the operator interface 110. The non-contact coupling component 120 receives a torque from the motor 130 when movement is initiated at the motor 130. The torque transfer function of the non-contact coupling component 120 effects the responsive behavior of the coupled component. The torque transfer function of the non-contact coupling component 120 effects the motion of the operator interface 110 when a torque is provided by the motor 130. The torque transfer function of the non-contact coupling component 120 effects the motion of the shaft of the motor 130 when a torque is provided by the operator interface 110.

The exemplary non-contact coupling component 120 (or more simply, a coupling component 120) shown in FIGS. 1A and 1B (a first type of coupling component 120) includes a combination of magnetic rings 123, 127, permeable rings (or flux transmitters) 125, and potentially energized magnetic rings 121. Different arrangements and grounding schemes may produce differing behavior. Gaps 129 between rings may be filled with viscous fluid to result in a speed-dependent transfer function. Magnetic ring(s) 121 may be either rigidly connected to the operator interface 110 or clutched. The motor 130 is rigidly coupled to a first rotating member 127 with a pattern of magnetic poles 128 alternating between north and south polarity. A second rotating member 123, which is concentric with the first rotating member 127, has magnetic poles 124 in a different pattern than the magnetic poles 128 of the first rotating member 127. A third rotating member 125 modulates the magnetic flux between the first rotating member 127 and the second rotating member 123. This configuration is analogous to a single-pass of a gear train, and the ratio between the number of magnetic poles on each of the rotating members informs the gear ratio between the motor 130 and the operator interface 110. The non-contact coupling component 120 can effect coupling in two directions—movement of the shaft of the motor 130 can cause movement in the operator interface 110, and optionally, movement of the operator interface 110 can cause movement in the shaft of the motor 130.

In the embodiment depicted in FIGS. 1A, 1B, there are a number of fluid-filled gaps 129: a gap 129 between the operator interface 110 and the magnetic ring(s) 121; a gap 129 between the magnetic ring(s) 121 and the second rotating member 123; a gap 129 between the second rotating member 123 and the permeable rings 125; and a gap 129 between the permeable rings 125 and the first rotating member 127. These gaps 129 permit magnetic or electromagnetic coupling between the various features in the coupling component 120.

FIGS. 1C, 1D, and 1E illustrate another embodiment of the portion of a control system 100. According to this embodiment, the non-contact coupling component has a slip torque that is adjustable by selectively aligning and misaligning pole pairs in a first portion 123a of an adjustable rotating member and a second portion 123b of the adjustable rotating member. As used herein, a pole pair includes a magnet from the first portion 123a and a magnet from the second portion 123b that have identical polarity orientations. FIG. 1C is similar to FIG. 1A, except that the second rotating member 123 is an adjustable rotating member and now comprises a first portion 123a and a second portion 123b, which are also illustrated in FIGS. 1D and 1E. Each of the first portion 123a and the second portion 123b include a series of magnets with reversed polarity with respect to adjacent magnets. The first portion 123a can be rotated with respect to the second portion 123b, or the second portion 123b can be rotated with respect to the first portion 123a. FIGS. 1D and 1E show how the orientation of the first portion 123a and the second portion 123b can be adjusted (rotated with respect to each other). The adjustment can be performed using, for example, a stepper motor or a screw or other mechanical means acting on one of the first portion 123a or the second portion 123b. The magnets in the first portion 123a or 123b may be retained in another rotating member (not shown), which can be mechanically adjusted such using, for example, the stepper motor or the screw.

In the example of FIGS. 1D and 1E, the second portion 123b rotates by adjustment with respect to the first portion 123a, although the converse is possible, or each of the first portion 123a and the second portion 123b may be individually rotatable by adjustment with respect to the other portion. This adjustable orientation of the first portion 123a and the second portion 123b allows for alignment and misalignment of the magnetic pole pairs between the first portion 123a and the second portion 123b. If the pole pairs are aligned (as in FIG. 1D), their magnetic fields may sum constructively, and the system behaves as if it only had a unitary second rotating member 123. When the pole pairs are misaligned (as in FIG. 1E), the magnetic flux is weakened towards the center. As a result, the ferromagnetic field can also weaken, reducing the overall torque in the system. When the pole pairs in the first portion 123a and the second portion 123b are completely misaligned (as in FIG. 1E), the magnetic field is effectively zero. By adjusting the alignment of the pole pairs in the first portion 123a and the second portion 123b, the system's slip torque can be varied during operation, for example, allowing an operator (e.g., pilot) to control the feedback system.

According to one embodiment, complete misalignment of the pole pairs occurs when the first portion 123a and the second portion 123b are rotated with respect to each other by ~12.6 degrees, although other amounts of angular rotation are possible. The maximum rotational angle may be defined by the angular spacing between adjacent magnets on a given one of the first portion 123a or the second portion 123b. For example, an example of maximum rotation is shown by comparing FIG. 1D with FIG. 1E, with the rotation of the second portion 123b in FIG. 1E being the maximum angle of rotation. The angular rotation can be variably adjusted between zero degrees (complete pole pair alignment) and up to the complete misalignment angle (e.g., variably adjusted between zero degrees and ~12.6 degrees). This results in a variable amount of slip torque in the system. The variability of the slip torque and the angular rotation may be substantially linear. The minimum slip torque (e.g., near zero in-lbs) occurs when the pole pairs in the first portion 123a and the second portion 123b are completely misaligned, and the maximum slip torque occurs when the pole pairs are completely aligned.

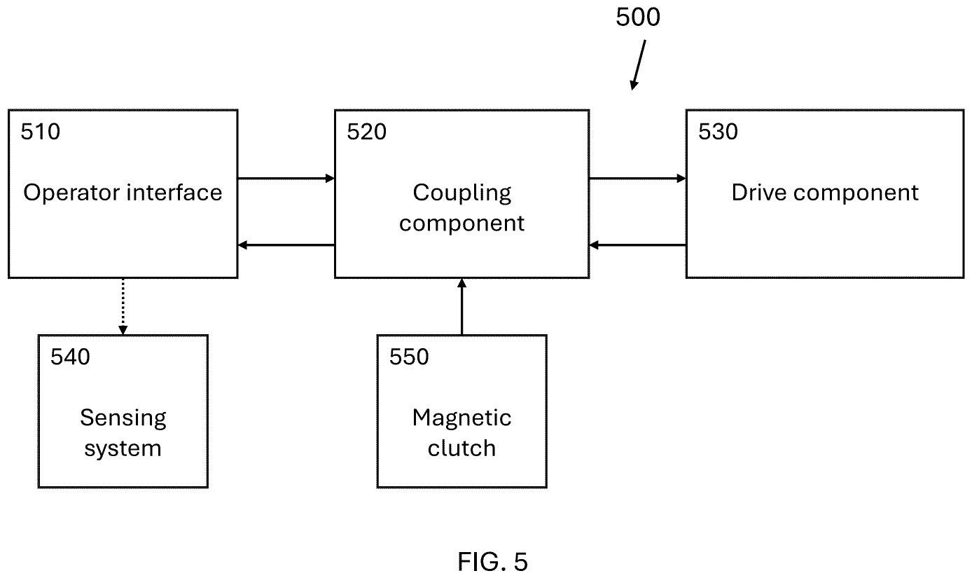

Further, one or more of the gaps 129 may be filled with damping liquid(s). Examples of damping liquids include magnetorheological fluid, silicon oil, or hydraulic oil. Magnetic or electromagnetic coupling may still occur across the damping liquid in a given gap 129. A given damping liquid may have a variable viscosity depending on conditions. For example, for a magnetorheological fluid may have a variable viscosity in the presence of a varying, controlling magnetic field. The presence of an electromagnetic field orients ferrous particles suspended in the magnetorheological fluid, thereby varying its viscosity. By varying the controlling magnetic field, it is possible to responsively adjust the viscosity of the magnetorheological fluid. This will be described in further detail in the context of FIG. 5 (magnetic clutch 550). Also, in the absence of this fluid, the magnetic rings 121 may be energized to emulate the torque transfer function by increasing the magnitude of magnetic coupling.

In the embodiment shown in FIGS. 1A and 1B, the operator interface 110 has back-driving capability over the motor 130. This will be discussed further in the context of FIG. 3. Further, in the embodiment shown in FIGS. 1A and 1B, the operator interface 110 can move independently from the motor 130 (e.g., by virtue of an operator exerting a force on the operator interface 110). In such a case, the non-contact coupling component 120 exhibits slippage, thereby reducing the potential for structural failure.

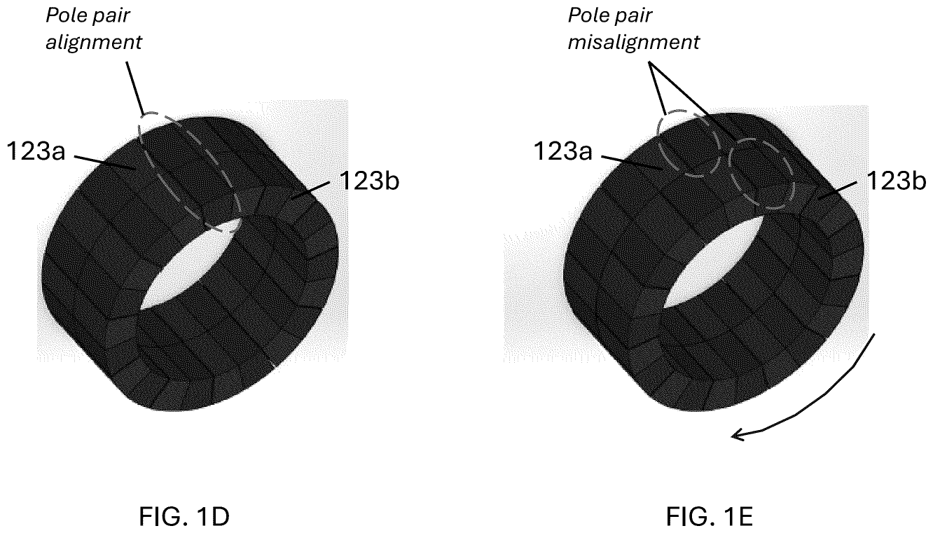

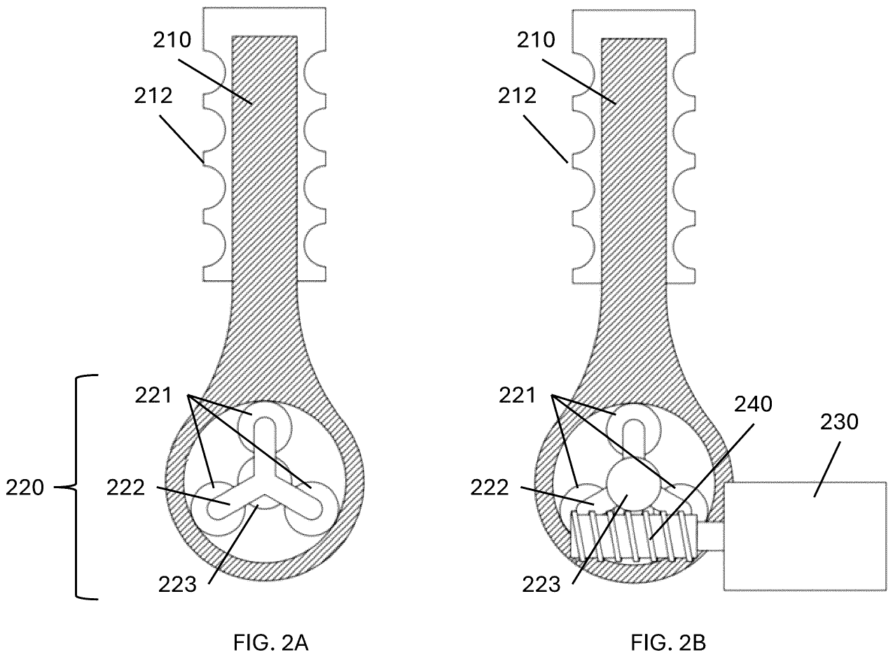

FIG. 2A illustrates an operator interface 210 and a second type of non-contact coupling component 220, according to embodiments. FIG. 2B illustrates the operator interface 210 and the second type of non-contact coupling component 220 with a motor 230 and a worm gear 240, according to embodiments. The operator interface 210 and handle 212 may be similar to the operator interface 110 and the handle 112, and descriptions of embodiments are not be repeated here.

The non-contact coupling component 220 includes a planetary gear system, including a sun gear 223, a cage 222, and planet gears 221. The sun gear 223 includes magnetic poles in a pattern (not shown). The sun gear 223 is rigidly coupled to a motor 230 (not shown in FIG. 2A). The planet gears 221 are statically coupled with each other via a cage 222. The sun gear 223 is also coupled to the cage 222. Each of the sun gear 223 and the planet gears 221 can rotate around their own respective center axis. Further, the cage 222 may have a fixed position, such that the sun gear 223 and the planet gears 221 each rotate but otherwise maintain fixed positions with respect to the static cage 222. In particular, each of the sun gear 223 and the planet gears 221 can have an axle that is rigidly coupled to the cage 222.

The planet gears 221 each have magnetic poles in a pattern (not shown). The pole pattern for a given planet gear 221 may be identical to the pole pattern on the sun gear 223. The planet gears 221 are oriented tangentially to an inner race in the aperture of the operator interface 210. There can be a gap (or gaps, not shown) between the planet gears 221 and the operator interface 210. The planet gears 221 magnetically couple to the operator interface 210 across the gaps.

There is a gap between the sun gear 223 and the planet gears 221 and cage 222. Rotation of the sun gear 223 (responsive to rotation of the shaft of the motor 230) causes responsive rotation of the planet gears 221 via magnetic coupling across the gap. Rotation of the planet gears 221 causes the planet gears 221 and the cage 222 to rotate within the operator interface 220. The movement of the planet gears 221 causes responsive movement in the operator interface 210. The responsive movement of the operator interface 210 may be a result of magnetic coupling with the planet gears 221.

In a similar but reverse manner, the movement of the operator interface 210 can be imparted to the shaft of the motor 130 via magnetic coupling. However, element(s) may be included in a system that prevent back-driving of the motor 130 by movement of the operator interface 210. For example, FIG. 2B shows a worm gear 240 that rigidly couples the shaft of the motor 230 with the sun gear 223. The worm gear 240 may prevent reverse motion of the shaft of the motor 130 due to attempted movement of the sun gear 223. However, because the sun gear 223 is not rigidly coupled to the planet gears 221 (instead they are magnetically coupled across an air gap), the planet gears 221 can slip with respect to the sun gear 223. That is, movement of the operator interface 210 (e.g., by an operator) causes movement of the planet gears 221, but not motion of the sun gear 223.

Further, in the embodiments shown in FIGS. 2A and 2B, the operator interface 210 can move independently from the motor 230 (e.g., by virtue of an operator exerting a force on the operator interface 210). In such a case, the non-contact coupling component 220 exhibits slippage, thereby reducing the potential for structural failure.

Whether in the embodiment of FIGS. 1A and 1B, or the embodiment of FIG. 2A, operator interface 110, 210 can have back-driving capability over the motor 130, 230. Alternatively, if the motor is irreversible (either due to an intermediate component, like the worm gear 240, or as a characteristic of the motor), the operator interface 110, 210 can rotate independently of the motor 130, 230. In the back-driven configuration, the motor 130, 230 is directly fixed to the input shaft (either the first rotating member 127 or the sun gear 223), and the primary feel to the operator at the operator interface 110, 210 comes from the internal inertia of the motor 130, 230. In the irreversible configuration, the primary lever feel comes from slippage within the coupling component 120, 220 (e.g., slippage between the planet gears 221 and sun gear 223).

The non-contact coupling component 220 receives a torque from the operator interface 210 when movement is initiated at the operator interface 210. The non-contact coupling component 220 receives a torque from the motor 230 when movement is initiated at the motor 230. The torque transfer function of the non-contact coupling component 220 effects the responsive behavior of the coupled component. The torque transfer function of the non-contact coupling component 220 effects the motion of the operator interface 210 when a torque is provided by the motor 230. The torque transfer function of the non-contact coupling component 220 effects the motion of the shaft of the motor 230 when a torque is provided by the operator interface 210.

In any of the embodiments shown in FIGS. 1A, 1B, 2A, and 2B, a damping device could be used to effect or influence coupling, for example, in scenarios that are dependent on speed. Alternatively, damping fluid can optionally be distributed in the gaps of the non-contact coupling components 120, 220. This fluid may optionally have magnetorheological properties, such that when electromagnetic coils and/or permeable materials are incorporated in the design, the fluid's viscosity can vary, thus giving the ability to emulate a torque transfer function. Also, in the absence of the damping fluid, electromagnetic coils and permeable materials being incorporated into the design may be used to emulate a torque transfer function by varying the magnitude of magnetic coupling.

FIG. 3 illustrates a block diagram of a control system 300 for a vehicle with a reversible drive component, according to embodiments. The control system 300 includes an operator interface 310, which may be similar to operator interfaces 110, 210. The control system 300 further includes a non-contact coupling component 320, which may be similar to the coupling components 120, 220. The control system 300 further includes a drive component 330, which is reversible, and may be similar to motors 130, 230. The control system 300 further includes a sensing system 340, which senses a position of the operator interface 310. The sensing system 340 may be one such as the sensing systems described herein. The sensing system 340 may cause an operation in the vehicle to be changed or adjusted, depending on the magnitude or degree of the sensed position of the operator interface 310.

When the operator interface 310 is moved by an operator, motion is induced in the coupling component 320, and then the drive component 330. The drive component 330 provides a responsive movement, resistance, or feel, which imparts a corresponding motion to the coupling component 320, and then back to the operator interface 310 to provide tactile feedback to the operator via feedback torque from the drive component 330. If the drive component 330 provides too much resistance to the coupling force from the coupling component 320, the coupling component 320 can slip, thereby preventing damage to the coupling component 320 or other portions of the system 300.

In reverse, motion can be originated at the drive component 330, which causes corresponding movement in the coupling component 320 and the operator interface 310. If motion in the operator interface 310 is inhibited (for example, if the operator is maintaining the position of the operator interface 310), then the coupling component 320 can slip, thereby preventing any potential damage to the coupling component 320 or other components in the system 300.

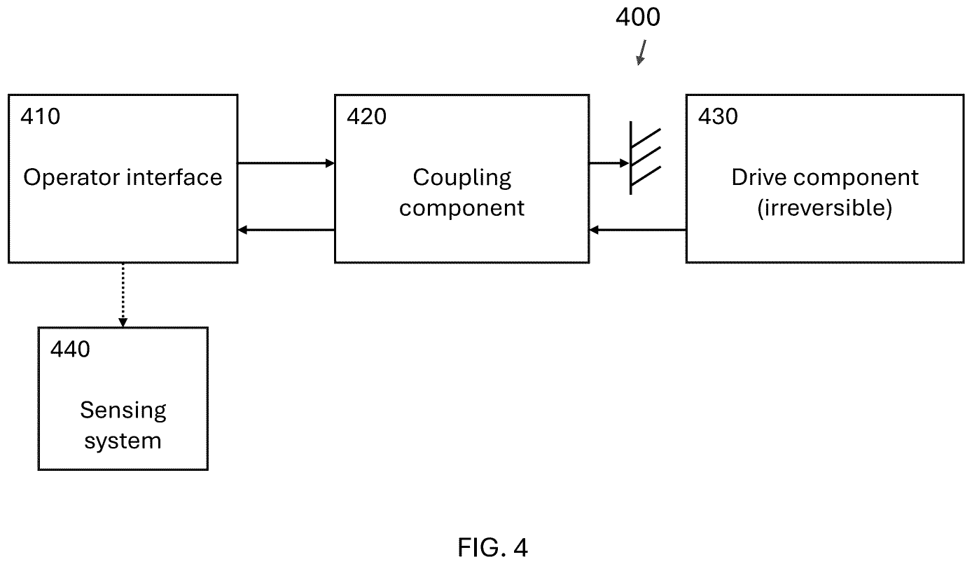

FIG. 4 illustrates a block diagram of a control system 400 for a vehicle with an irreversible drive component 430, according to embodiments. The components of system 400 (operator interface 410, coupling component 420, sensing system 440) may be similar to those of control system 300, (operator interface 410, coupling component 420, sensing system 440) with the exception that the drive component 430 is irreversible (i.e., it can only cause movement in one direction). The drive component 430 may be irreversible due to a characteristic of the drive component 430 itself, or due to another component, such as the worm gear 240. As shown, the drive component 430 does not receive a coupling force from the coupling component 420 (or at least does not functionally act on the received coupling force). In such a configuration, the operator of the operator interface 410 will not receive haptic feedback due to the resistance or torque of the drive component 430. However, the drive component 430 may still provide an output torque that causes responsive movement in the operator interface 410 via the coupling component 420. Further, if a damping fluid is included in the coupling component 520, the operator of the operator interface 510 may receive haptic feedback due to the viscosity and behavior of the damping fluid.

FIG. 5 illustrates a block diagram of a control system 500 for a vehicle with a magnetic clutch 550, according to embodiments. The control system 500 embodiment depicted includes an operator interface 510, a coupling component 520, a drive component 530, and a sensing system 540. These components may be similar to the operator interfaces 310, 410, the coupling components 320, 420, the drive components 330, 430, and/or the sensing systems 340, 440, respectively, and as such, their operation will not be repeated here.

The control system 500 further includes a magnetic clutch 550 which acts on a magnetorheological damping fluid in the coupling component 520. The magnetic clutch 550 exhibits a magnetic field that is coupled with the magnetorheological damping fluid, using permanent magnets or electromagnets. The exhibited magnetic field may be variable, and may be controlled in a particular manner. Such control may be performed by a processor, and may be determined according to inputs such as sensed conditions from the sensing system 540. The exhibited magnetic field causes changes in the viscosity of the magnetorheological damping fluid, such that the torque transfer function of the coupling component 520 is adjusted.

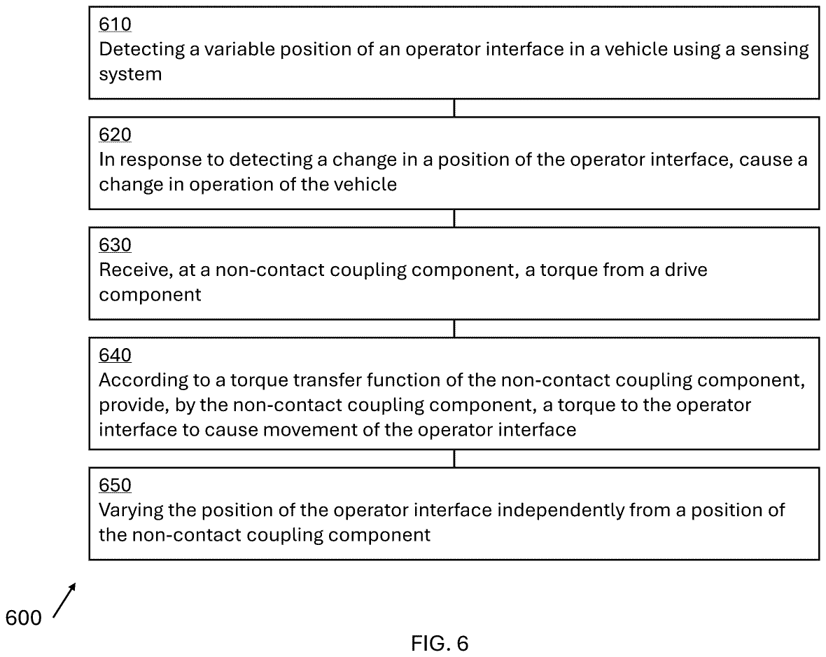

FIG. 6 is a flowchart 600 for a method of controlling an operator interface of a vehicle, according to embodiments. Additional steps may be performed in the method, or some steps could be removed. Steps may be performed in a different sequence, or partially or completely simultaneously. The flowchart 600 is described in context of system 500, but is not so limited.

At step 610, a variable position of the operator interface 510 is detected using a sensing system 540. In an example, the operator interface 510 is a lever in an aircraft, and the sensing system 540 senses the position of the operator interface 510 as it is moved by an operator of the aircraft.

At step 620, in response to detecting a change in the position of the operator interface 510, an operation of the vehicle is changed. In an example, the ascent/descent of an aircraft is changed according to a position of the operator interface 510 sensed by the sensing system 540.

At step 630, a torque from the drive component 530 is received at the non-contact coupling component 520. In the case of the drive component 530 being a motor, a shaft of the motor may be rigidly attached to the non-contact coupling component 520, such that a torque provided by the shaft is received at the non-contact coupling component 520.

At step 640, a torque is provided by the non-contact coupling component 520 to the operator interface 510 according to a torque transfer function of the non-contact coupling component 520 to cause movement of the operator interface 510. The movement can provide tactile feedback by, for example, causing vibrations in the operator interface 510. The torque transfer function may also increase and/or decrease resistance of the operator interface 510.s

At step 650, the position of the operator interface 510 is varied independently from a position of the non-contact coupling component 520. For example, an operator can exert a force on the operator interface 510, thereby causing slippage in the non-contact coupling component 520.

Some or all of the magnets disclosed herein can be permanent magnets and/or electromagnets. In the case of electromagnets, additional electrical circuitry would provide energization to the electromagnet. Such circuitry is not depicted herein, but is understood.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A control system for a vehicle, comprising:
an operator interface;
a sensing system configured to detect a variable position of the operator interface and cause a change in operation of the vehicle;
a drive component; and
a non-contact coupling component coupled to the operator interface and to the drive component, wherein the non-contacting coupling component exhibits a torque transfer function,
wherein the non-contact coupling component is configured to receive a torque from the drive component and, according to the torque transfer function, the non-contact coupling component is configured to provide a torque to the operator interface to cause movement of the operator interface, and
wherein the variable position of the operator interface is configured to vary independently from a position of the non-contact coupling component.

2. The control system of claim 1, wherein the control system is configured such that a movement of the operator interface causes a responsive movement in the drive component.

3. The control system of claim 2, wherein the drive component is configured to provide a torque to the non-contact coupling component in response to the movement of the operator interface causing the responsive movement in the drive component, such that a feedback torque is received by the operator interface.

4. The control system of claim 1, wherein the control system is configured such that a movement of the operator interface does not cause a responsive movement in the drive component.

5. The control system of claim 1, wherein the non-contact coupling component includes a plurality of magnets configured to effect coupling between the operator interface and the drive component.

6. The control system of claim 1, wherein the non-contact coupling component includes a damping fluid configured to effect coupling between the operator interface and the drive component.

7. The control system of claim 6, wherein the damping fluid comprises a magnetorheological fluid.

8. The control system of claim 1, wherein the non-contact coupling component comprises a planetary magnetic gear system.

9. The control system of claim 1, wherein the non-contact coupling component has a slip torque that is adjustable by selectively aligning and misaligning pole pairs in a first portion of an adjustable rotating member and a second portion of the adjustable rotating member.

10. The control system of claim 9, wherein the non-contact coupling component comprises:
a first rotating member with a pattern of magnetic poles alternating between north and south polarity;
a second rotating member concentric with the first rotating member, wherein the second rotating member includes magnetic poles in a different pattern than the magnetic poles of the first rotating member, wherein the second rotating member comprises the adjustable rotating member; and
a third rotating member, wherein the third rotating member modulates the magnetic flux between the first rotating member and the second rotating member.

11. The control system of claim 1, wherein the variable position of the operator interface is configured to vary independently from a position of the non-contact coupling component in response to receiving an external force at the operator interface.

12. A method for controlling an operator interface of a vehicle, the method comprising:
detecting a variable position of the operator interface using a sensing system;
in response to detecting a change in a position of the operator interface, cause a change in operation of the vehicle;
receive, at a non-contact coupling component, a torque from a drive component;
according to a torque transfer function of the non-contact coupling component, provide, by the non-contact coupling component, a torque to the operator interface to cause movement of the operator interface; and
varying the position of the operator interface independently from a position of the non-contact coupling component.

13. The method of claim 12, further comprising:
moving the operator interface; and
in response to moving the operator interface, causing a responsive movement in the drive component.

14. The method of claim 13, further comprising providing, by the drive component, a torque to the non-contact coupling component in response to moving the operator interface causing the responsive movement in the drive component, such that a feedback torque is received by the operator interface.

15. The method of claim 12, wherein a movement of the operator interface does not cause a responsive movement in the drive component.

16. The method of claim 12, wherein the non-contact coupling component includes a plurality of magnets configured to effect coupling between the operator interface and the drive component.

17. The method of claim 12, wherein the non-contact coupling component includes a damping fluid configured to effect coupling between the operator interface and the drive component.

18. The method of claim 17, wherein the damping fluid comprises a magnetorheological fluid.

19. The method of claim 12, wherein the non-contact coupling component comprises a planetary magnetic gear system.

20. The method of claim 12, wherein the non-contact coupling component has a slip torque that is adjustable by selectively aligning and misaligning pole pairs in a first portion of an adjustable rotating member and a second portion of the adjustable rotating member.

21. The control system of claim 20, wherein the non-contact coupling component comprises:
a first rotating member with a pattern of magnetic poles alternating between north and south polarity;
a second rotating member concentric with the first rotating member, wherein the second rotating member includes magnetic poles in a different pattern than the magnetic poles of the first rotating member, wherein the second rotating member comprises the adjustable rotating member; and
a third rotating member, wherein the third rotating member modulates the magnetic flux between the first rotating member and the second rotating member.

22. The method of claim 12, further comprising varying the position of the operator interface independently from a position of the non-contact coupling component in response to receiving an external force at the operator interface.
